(19) United States
(12) Patent Application Publication
(10) Pub. No.: US 2025/0137483 A1
(43) Pub. Date: May 1, 2025

(54) ROTATION DEVICE

(71) Applicant: IHI Corporation, Tokyo (JP)

(72) Inventors: Koji SAKOTA, Tokyo (JP); Taiki YOSHIZAKI, Tokyo (JP); Hideyuki KOJIMA, Tokyo (JP)

(73) Assignee: IHI Corporation, Tokyo (JP)

(21) Appl. No.: 19/010,270

(22) Filed: Jan. 6, 2025

Related U.S. Application Data
(63) Continuation of application No. PCT/JP2023/018833, filed on May 19, 2023.

(30) Foreign Application Priority Data
Sep. 30, 2022 (JP) 2022-158185

(51) Int. Cl. F16C 3/02; F02B 37/00; F02C 6/12; F04D 29/053

(52) U.S. Cl. CPC F16C 3/02; F02B 37/00; F02C 6/12; F04D 29/053

(57) ABSTRACT

A rotation device includes one or more plates that define a part of a flow path, and a plurality of vanes that are arranged in the flow path, each of the plurality of vanes including a vane body that is located in the flow path, and a shaft that is rotatably supported by one or more holes provided in the one or more plates, the shaft including an R shape at both ends in an axial direction of a contact part between the shaft and the one or more holes.

### CROSS REFERENCE TO RELATED APPLICATIONS

This application is a continuation application of International Application No. PCT/JP2023/018833, filed on May 19, 2023, which claims priority to Japanese Patent Application No. 2022-158185 filed on Sep. 30, 2022, the entire contents of which are incorporated herein by reference.

### BACKGROUND ART

### Technical Field

The present disclosure relates to a rotation device.

A rotation device such as a turbine or a compressor may include movable vanes to adjust a width (cross-sectional area) of a flow path. For example, Patent Literature 1 discloses a centrifugal turbine including guide vanes. The guide vane is connected to a vane shaft. The vane shaft is rotatably attached to a housing. The guide vane rotates integrally with the vane shaft. By controlling a rotational angle of the guide vane, a width of a flow path is adjusted.

### CITATION LIST

### Patent Literature

Patent Literature 1: JP 2009-523957 A

### SUMMARY

### Technical Problem

Vanes are subjected to loads from a fluid. When a shaft is tilted by the load, the shaft may contact a hole that supports the shaft in a local area. Such local contact may cause an excessive contact stress which may prevent smooth rotation of the vane.

The purpose of the present disclosure is to provide a rotation device that can reduce a contact stress between a shaft of a movable vane and a hole.

### Solution to Problem

In order to solve the above problem, a rotation device according to one aspect of the present disclosure includes one or more plates that define a part of a flow path, and a plurality of vanes that are arranged in the flow path, each of the plurality of vanes including a vane body that is located in the flow path, and a shaft that is rotatably supported by one or more holes provided in the one or more plates, the shaft including an R shape at both ends in an axial direction of a contact part between the shaft and the one or more holes.

The shaft may include at least one tapered part that is formed continuous with the R shape, and the at least one tapered part may be at least partially arranged inside of the one or more holes.

A radius of the R shape may be 0.5 mm or more and 1.0 mm or less.

### Effects

According to the present disclosure, a contact stress between the shaft of the movable vane and the hole can be reduced in the rotation device.

### BRIEF DESCRIPTION OF DRAWINGS

FIG. 1 is a schematic cross-sectional view of a turbocharger including a turbine according to an embodiment.

FIG. 2 is an enlarged cross-sectional view of section A in FIG. 1.

FIG. 3 is an enlarged cross-sectional view of section B in FIG. 2.

FIG. 4 is an enlarged cross-sectional view of section C in FIG. 2.

### DESCRIPTION OF EMBODIMENTS

An embodiment of the present disclosure will be described in detail below with reference to the accompanying drawings. Specific dimensions, materials, and numerical values described in the embodiment are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

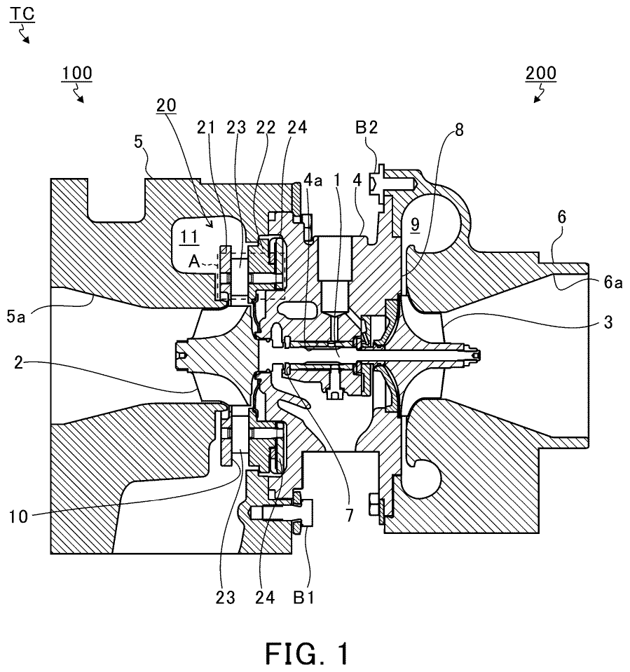

FIG. 1 is a schematic cross-sectional view of a turbocharger TC including a turbine 100 according to an embodiment. In the present embodiment, the turbine (rotation device) 100 is incorporated into the turbocharger TC. In another embodiment, the turbine 100 may be incorporated into a device other than the turbocharger TC, or it may be a stand-alone device.

The turbocharger TC includes a shaft 1, a turbine impeller 2, a compressor impeller 3, a bearing housing 4, a turbine housing 5, and a compressor housing 6.

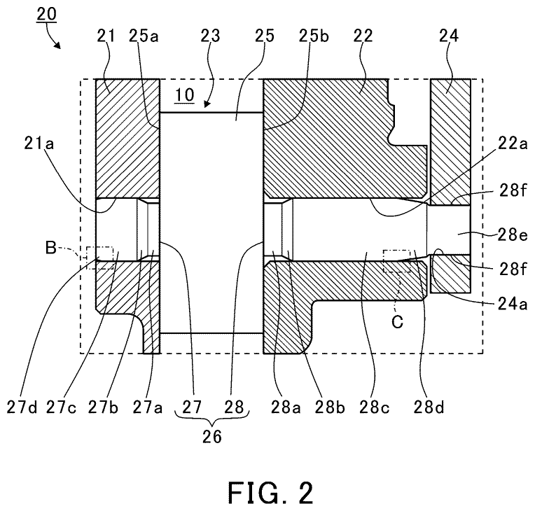

The turbine housing 5 is connected to a first end face (left end face in FIG. 1) of the bearing housing 4 by fastening bolts B1. The compressor housing 6 is connected to a second end face (right end face in FIG. 2) that is opposite to the first end face of the bearing housing 4 by fastening bolts B2.

The bearing housing 4 includes a bearing hole 4a. The bearing hole 4a extends in the bearing housing 4 along an axial direction of the shaft 1. The bearing hole 4a accommodates a bearing 7. In the present embodiment, a semi-floating bearing is shown as an example of the bearing 7. In another embodiment, the bearing 7 may be other radial bearing such as a full-floating bearing or a rolling bearing. The bearing 7 rotatably supports the shaft 1.

The turbine impeller 2 is provided at a first end (left end in FIG. 1) of the shaft 1. The turbine impeller 2 rotates integrally with the shaft 1. The turbine impeller 2 is rotatably accommodated in the turbine housing 5. The compressor impeller 3 is provided at a second end (right end in FIG. 1) that is opposite to the first end of the shaft 1. The compressor impeller 3 rotates integrally with the shaft 1. The compressor impeller 3 is rotatably accommodated in the compressor housing 6.

The compressor housing 6 includes an inlet 6a at an end that is opposite to the bearing housing 4. The inlet 6a is connected to an air cleaner (not shown). The bearing housing 4 and the compressor housing 6 define a diffuser flow path 8 therebetween. The diffuser flow path 8 has an annular shape. The diffuser flow path 8 is located outside of the compressor impeller 3 in a radial direction of the compressor impeller 3. The diffuser flow path 8 is connected to the inlet 6a through the compressor impeller 3.

The compressor housing 6 includes a compressor scroll flow path 9. The compressor scroll flow path 9 is located outside of the diffuser flow path 8 in the radial direction of the compressor impeller 3. The compressor scroll flow path 9 is connected to the diffuser flow path 8. Furthermore, the compressor scroll flow path 9 is connected to an intake port of an engine (not shown).

As the compressor impeller 3 rotates, air is sucked into the compressor housing 6 from the inlet 6a. The intake air is accelerated and pressurized by centrifugal force while passing through blades of the compressor impeller 3. The air is further pressurized in the diffuser flow path 8 and the compressor scroll flow path 9. The pressurized air flows out of an outlet (not shown) and is directed to the intake port of the engine. In the turbocharger TC, a part that includes the compressor impeller 3 and the compressor housing 6 functions as a centrifugal compressor 200.

The turbine housing 5 includes an outlet 5a at an end that is opposite to the bearing housing 4. The outlet 5a is connected to an exhaust gas purifier (not shown). The turbine housing 5 includes a connecting flow path 10. The connecting flow path 10 has an annular shape. The connecting flow path 10 is located outside of the turbine impeller 2 in the radial direction of the turbine impeller 2. The connecting flow path 10 is connected to the outlet 5a through the turbine impeller 2.

The turbine housing 5 includes a turbine scroll flow path 11. The turbine scroll flow path 11 is located outside of the connecting flow path 10 in the radial direction of the turbine impeller 2. The turbine scroll flow path 11 is connected to the connecting flow path 10. Furthermore, the turbine scroll flow path 11 is connected to a gas inlet (not shown). The gas inlet receives exhaust gas discharged from an exhaust manifold of the engine (not shown).

The exhaust gas is directed from the gas inlet to the turbine scroll flow path 11, and further directed to the outlet 5a through the connecting flow path 10 and the turbine impeller 2. The exhaust gas rotates the turbine impeller 2 while passing through blades of the turbine impeller 2. A rotational force of the turbine impeller 2 is transmitted to the compressor impeller 3 via the shaft 1. As the compressor impeller 3 rotates, air is sucked into the inlet 6a, and accelerated and pressurized by the compressor impeller 3 as described above. In the turbocharger TC, a part that includes the turbine impeller 2 and the turbine housing 5 functions as the turbine 100.

As a flow rate of the exhaust gas directed to the turbine housing 5 changes, a rotational rate of the turbine impeller 2 and the compressor impeller 3 also changes. Accordingly, the air directed to the intake port of the engine may not be pressurized to a desired pressure, depending on an operating condition of the engine. In order to adjust a flow velocity of the exhaust gas passing through the turbine impeller 2 depending on the operating condition of the engine, the turbocharger TC of the present disclosure includes a nozzle mechanism 20 that changes a width (area) of the flow path in the turbine housing 5, specifically a width of the flow path in the connecting flow path 10.

The nozzle mechanism 20 changes the flow velocity of the exhaust gas directed to the turbine impeller 2, depending on the flow rate of the exhaust gas. Specifically, the nozzle mechanism 20 reduces the width of the flow path when the rotational rate of the engine is low and the flow rate of the exhaust gas is low. As such, the flow velocity of the exhaust gas directed to the turbine impeller 2 is improved, and the turbine impeller 2 can be rotated with the low flow rate.

The nozzle mechanism 20 includes a first plate 21 and a second plate 22 (one or more plates), a plurality of movable nozzle vanes (vanes) 23, and a plurality of link plates 24. The nozzle mechanism 20 may further include other components such as an actuator (not shown), for example.

In the present embodiment, the first plate 21 has a substantially annular shape. The first plate 21 is arranged coaxially with the turbine impeller 2 between the turbine impeller 2 and the turbine scroll flow path 11.

In the present embodiment, the second plate 22 has a substantially annular shape. The second plate 22 is arranged coaxially with the turbine impeller 2 between the turbine impeller 2 and the turbine scroll flow path 11. The second plate 22 is positioned parallel to and faces the first plate 21 across a gap.

The first plate 21 and the second plate 22 define the above-described connecting flow path 10 therebetween. In other words, the first plate 21 and the second plate 22 define a part (connecting flow path 10) of the exhaust gas flow path that extends from the gas inlet to the outlet 5a in the turbine housing 5.

The nozzle vanes 23 are arranged in the connecting flow path 10. In other words, the nozzle vanes 23 are arranged between the first plate 21 and the second plate 22. The plurality of nozzle vanes 23 are arranged along a circumferential direction of the turbine impeller 2.

FIG. 2 is an enlarged cross-sectional view of section A in FIG. 1. In the present embodiment, each nozzle vane 23 is rotatably supported by the first plate 21 and the second plate 22. Specifically, each nozzle vane 23 includes a vane body 25 and a shaft 26.

The vane body 25 is located in the connecting flow path 10. In other words, the vane body 25 is located between the first plate 21 and the second plate 22. The vane body 25 changes a direction of a flow of the exhaust gas depending on a rotational angle.

The shaft 26 is connected to the vane body 25. For example, the shaft 26 may be integrally formed with the vane body 25. Alternatively, the shaft 26 may be a separate component from the vane body 25, and may be fixed to the vane body 25 by, for example, welding or adhesive. In the present embodiment, the shaft 26 includes a first shaft part 27 and a second shaft part 28.

The first shaft part 27 protrudes from a first end face 25a (left end face in FIG. 2) of the vane body 25 toward the first plate 21. The first plate 21 includes a plurality of first through holes 21a along the circumferential direction of the turbine impeller 2. Note that only one first through hole 21a is shown in FIG. 2. The first shaft part 27 is inserted into the first through hole 21a. The length of the first shaft part 27 is substantially the same as the length of the first through hole 21a. In other words, a protruding end of the first shaft part 27 and an end face of the first plate 21 are substantially flush with each other.

The first shaft part 27 includes a first neck 27a, a first tapered part 27b, a first contact part 27c, and a second tapered part 27d, in the order closer to the vane body 25 along an axial direction.

The first neck 27a is connected to the vane body 25. The first neck 27a has a cylindrical shape. The first neck 27a has a constant diameter along the axial direction. The diameter of the first neck 27a is smaller than an inner diameter of the first through hole 21a. As such, there is a gap between the first neck 27a and the first through hole 21a.

The first tapered part 27b connects the first contact part 27c and the first neck 27a. The first tapered part 27b is tapered from the first contact part 27c to the first neck 27a. The minimum diameter of the first tapered part 27b is equal to the diameter of the first neck 27a. Furthermore, the maximum diameter of the first tapered part 27b is equal to a diameter of the first contact part 27c.

The first contact part 27c is connected to the first tapered part 27b. The first contact part 27c has a cylindrical shape. The first contact part 27c has a constant diameter along the axial direction. The diameter of the first contact part 27c is substantially the same as or slightly smaller than the inner diameter of the first through hole 21a. Accordingly, the first shaft part 27 is in contact with the first through hole 21a at the first contact part 27c and rotatably supported by the first through hole 21a.

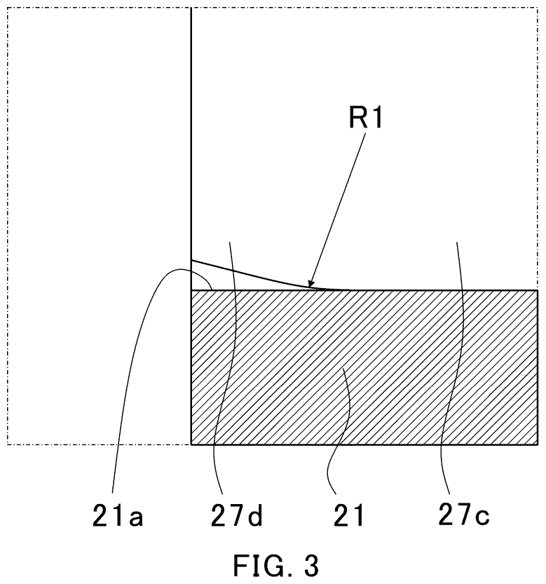

FIG. 3 is an enlarged cross-sectional view of section B in FIG. 2. FIG. 3 shows a connection part between the first contact part 27c and the second tapered part 27d described above.

The second tapered part 27d is connected to the first contact part 27c. The second tapered part 27d includes the protruding end of the first shaft part 27. The second tapered part 27d is tapered from the first contact part 27c to the protruding end of the first shaft part 27. The maximum diameter of the second tapered part 27d is substantially equal to the diameter of the first contact part 27c, although there is no clear edge between the second tapered part 27d and the first contact part 27c as described later. The minimum diameter of the second tapered part 27d is smaller than the inner diameter of the first through hole 21a. The entirety or most of the second tapered part 27d is located inside of the first through hole 21a. In another embodiment, the second tapered part 27d may be partially located outside of the first through hole 21a.

The connection part between the first contact part 27c and the second tapered part 27d is rounded and includes a first R shape R1. Accordingly, the first contact part 27c and the second tapered part 27d are smoothly connected to each other without an edge. In other words, the second tapered part 27d is formed continuous with the first R shape R1.

Returning to FIG. 2, the second shaft part 28 protrudes from a second end face 25b (right end face in FIG. 2) of the vane body 25 toward the second plate 22. The second shaft part 28 is parallel and coaxial to the first shaft part 27. The second plate 22 includes a plurality of second through holes 22a along the circumferential direction of the turbine impeller 2. Note that only one second through hole 22a is shown in FIG. 2. The second shaft part 28 is inserted into the second through hole 22a. The second shaft part 28 protrudes to an outside of the second through hole 22a. In other words, a protruding end of the second shaft part 28 is located outside of the second through hole 22a.

The second shaft part 28 includes a second neck 28a, a third tapered part 28b, a second contact part 28c, a fourth tapered part 28d, and a coupling part 28e, in the order closer to the vane body 25 along an axial direction.

The second neck 28a is connected to the vane body 25. The second neck 28a has a cylindrical shape. The second neck 28a has a constant diameter along the axial direction. The diameter of the second neck 28a is smaller than an inner diameter of the second through hole 22a. Accordingly, there is a gap between the second neck 28a and the second through hole 22a.

The third tapered part 28b connects the second contact part 28c and the second neck 28a. The third tapered part 28b is tapered from the second contact part 28c to the second neck 28a. The minimum diameter of the third tapered part 28b is equal to the diameter of the second neck 28a. Furthermore, the maximum diameter of the third tapered part 28b is equal to a diameter of the second contact part 28c.

The second contact part 28c is connected to the third tapered part 28b. The second contact part 28c has a cylindrical shape. The second contact part 28c has a constant diameter along the axial direction. The diameter of the second contact part 28c is substantially the same as or slightly smaller than the inner diameter of the second through hole 22a. Accordingly, the second shaft part 28 is in contact with the second through hole 22a at the second contact part 28c and rotatably supported by the second through hole 22a. In the present embodiment, the diameter of the second contact part 28c is equal to the diameter of the first contact part 27c. In another embodiment, the diameter of the second contact part 28c may be different from the diameter of the first contact part 27c.

The fourth tapered part 28d connects the second contact part 28c and the coupling part 28e. The fourth tapered part 28d is tapered from the second contact part 28c to the coupling part 28e. The maximum diameter of the fourth tapered part 28d is substantially equal to the diameter of the second contact part 28c, although there is no clear edge between the fourth tapered part 28d and the second contact part 28c as described below. Furthermore, the minimum diameter of the fourth tapered part 28d is equal to a diameter of the coupling part 28e. Note that the coupling part 28e has a cylindrical shape including notches 28f as described below, and the diameter of the coupling part 28e is shown smaller in FIG. 2 because of the notches 28f. The entirety or most of the fourth tapered part 28d is located inside of the second through hole 22a. In another embodiment, the fourth tapered part 28d may be partially located outside of the second through hole 22a.

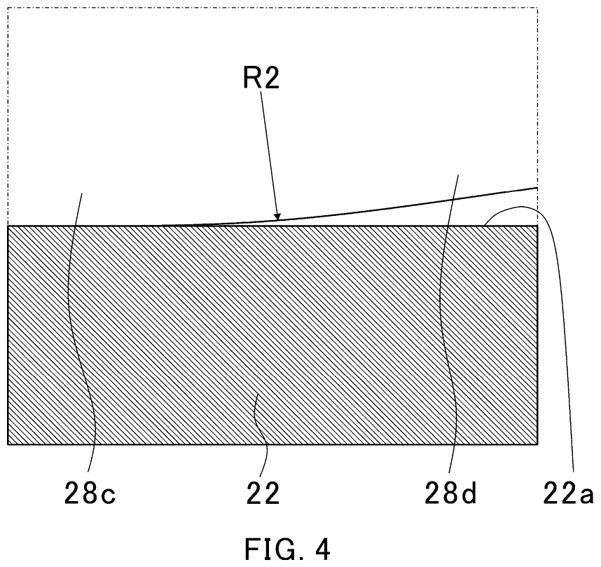

FIG. 4 is an enlarged cross-sectional view of section C in FIG. 2. FIG. 4 shows a connection part between the second contact part 28c and the fourth tapered part 28d described above.

The connection part between the second contact part 28c and the fourth tapered part 28d is rounded and connected by a second R shape R2. Accordingly, the second contact part 28c and the fourth tapered part 28d are smoothly connected to each other without an edge. In other words, the fourth tapered part 28d is continuous with the second R shape R2.

Returning to FIG. 2, the coupling part 28e is connected to the fourth tapered part 28d. The coupling part 28e includes the protruding end of the second shaft part 28. The coupling part 28e has a cylindrical shape including one or more notches 28f on its side. In FIG. 2, the coupling part 28e includes two notches 28f. The coupling part 28e has a constant diameter along the axial direction. The diameter of the coupling part 28e is smaller than the inner diameter of the second through hole 22a. The coupling part 28e is located outside of the second through hole 22a.

The link plate 24 is provided for each of the plurality of nozzle vanes 23. The link plate 24 is attached to the coupling part 28e. Specifically, the link plate 24 includes a through hole 24a. The through hole 24a has a cross section corresponding to the shape of the coupling part 28e. The coupling part 28e is inserted into the through hole 24a.

In the nozzle mechanism 20 as described above, each link plate 24 is rotated simultaneously with the other link plates 24 around a corresponding shaft 26 by one disc (not shown) rotated by an actuator. As the link plate 24 rotates, the shaft 26 attached to the link plate 24 integrally rotates with the link plate 24. Furthermore, the vane body 25 integrally rotates with the shaft 26. As a result, the width of the connecting flow path 10 is changed.

The vane body 25 receives a load from the exhaust gas. The shaft 26 may be tilted by the load. In this case, the shaft 26 may contact the through holes 21a and 22a in local areas.

Specifically, in the present embodiment, the shaft 26 includes the first shaft part 27 and the second shaft part 28 as described above. Accordingly, the shaft 26 contacts the first through hole 21a at the first contact part 27c of the first shaft part 27, and contacts the second through hole 22a at the second contact part 28c of the second shaft part 28.

When the shaft 26 is tilted, the shaft 26 contacts the through holes 21a and 22a at axial ends in the entire contact parts 27c and 28c, specifically, at the connection part between the first contact part 27c and the second tapered part 27d as one end, and at the connection part between the second contact part 28c and the fourth tapered part 28d as the other end. Such local contact may cause excessive contact stress, and may hinder smooth rotation of the nozzle vane 23.

However, in the present embodiment, as shown in FIG. 3, the shaft 26 includes the first R shape R1 having a radiused shape (arc shape) at the one end of the contact parts in the axial direction, i.e., at the connection part between the first contact part 27c and the second tapered part 27d. Accordingly, when the shaft 26 is tilted, the first R shape R1 contacts the first through hole 21a. As a result, point contact between the first shaft part 27 and the first through hole 21a is avoided. Accordingly, the contact stress between the first shaft part 27 and the first through hole 21a can be reduced.

Furthermore, in the present embodiment, as shown in FIG. 4, the shaft 26 includes the second R shape R2 having a radiused shape (arc shape) at the other end of the contact parts in the axial direction, i.e., at the connection part between the second contact part 28c and the fourth tapered part 28d. Accordingly, when the shaft 26 is tilted, the second R shape R2 contacts the second through hole 22a. As a result, point contact between the second shaft part 28 and the second through hole 22a is avoided. Accordingly, the contact stress between the second shaft part 28 and the second through hole 22a can be reduced.

For example, the radii of the first R shape R1 and the second R shape R2 may be determined by analysis or experiment so that the contact stresses in the first R shape R1 and the second R shape R2 do not exceed the plastic flow pressure under expected loading conditions. The “plastic flow pressure” refers to a stress at which a material begins to deform irreversibly. For example, the radii of the first R shape R1 and the second R shape R2 may be 0.5 mm or more and 1.0 mm or less. If the radius is smaller than 0.5 mm, machining of the R shape is difficult and manufacturing cost may increase. If the radius is larger than 1.0 mm, it can be difficult to ensure sufficient axial length of the contact parts 27c and 28c to withstand expected loading conditions. However, the radii of the first R shape R1 and the second R shape R2 are not limited to the above-described range, and may be modified according to various factors such as operating conditions of the turbine 100. For example, the first R shape R1 and the second R shape R2 may be formed by various machining methods, such as rounding.

As described above, the turbine 100 of the present embodiment includes the first plate 21 and the second plate 22 that define the connecting flow path 10, and the plurality of nozzle vanes 23 that are arranged in the connecting flow path 10. Each of the plurality of nozzle vanes 23 includes the vane body 25 that is arranged in the connecting flow path 10 and the shaft 26 that is rotatably supported by the first through hole 21a in the first plate 21 and the second through hole 22a in the second plate 22. The shaft 26 includes the R shape R1, R2 at the both ends in the axial direction of the contact parts 27c and 28c between the shaft 26 and the through holes 21a and 22a. According to such a configuration, since the R shapes R1 and R2 contact the through holes 21a and 22a when the shaft 26 is tilted, point contact between the shaft 26 and the through holes 21a and 22a is avoided. As such, the contact stress between the shaft 26 and the through holes 21a and 22a can be reduced.

Furthermore, in the turbine 100, the shaft 26 includes the second tapered part 27d that is formed continuous with the first R shape R1, and the second tapered part 27d is at least partially arranged inside of the first through hole 21a. According to such a configuration, the shaft 26 is gently spaced apart from a surface of the first through hole 21a at the second tapered part 27d. As such, when the shaft 26 is tilted, the first R shape R1 more easily contacts the first through hole 21a, and the contact area between the first R shape R1 and the first through hole 21a is increased. As a result, the contact stress between the shaft 26 and the first through hole 21a can be reduced more.

Similarly, in the turbine 100, the shaft 26 includes the fourth tapered part 28d that is formed continuous with the second R shape R2, and the fourth tapered part 28d is at least partially arranged inside of the second through hole 22a. According to such a configuration, the shaft 26 is gently spaced apart from a surface of the second through hole 22a at the fourth tapered part 28d. As such, when the shaft 26 is tilted, the second R shape R2 more easily contacts the second through hole 22a, and the contact area between the second R shape R2 and the second through hole 22a is increased. As a result, the contact stress between the shaft 26 and the second through hole 22a can be reduced more.

Furthermore, in the turbine 100, the radius of the R shape R1, R2 is 0.5 mm or more and 1.0 mm or less. According to such a configuration, it is possible to curb the increase in manufacturing cost and to secure sufficient axial lengths of the contact parts 27c and 28c.

Although an embodiment of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, the present invention is applied to the turbine 100 in the above-described embodiment. In another embodiment, the present invention may be applied to a variable-capacity rotation device other than a turbine. For example, the present invention may be applied to the centrifugal compressor 200. In this case, for example, movable vanes may be provided in the diffuser flow path 8 of the centrifugal compressor 200.

Furthermore, referring to FIG. 2, the shaft 26 is supported by both the first plate 21 and the second plate 22 in the above-described embodiment. In another embodiment, for example, the shaft 26 may be supported by only the second plate 22. In this case, the nozzle vane 23 may not include the first shaft part 27. In such a configuration, when the shaft 26 (second shaft part 28) is tilted, the shaft 26 contacts the second through hole 22a at the connection part between the third tapered part 28b and the contact part 28c as one end of the contact part 28c in the axial direction, and at the connection part between the contact part 28c and the fourth tapered part 28d as the other end of the contact part 28c in the axial direction. Accordingly, in this case, R-shape may also be formed at the connection part between the third tapered part 28b and the contact part 28c.

Furthermore, in the above embodiment, the shaft 26 includes the second tapered part 27d formed continuous with the first R shape R1, and the fourth tapered part 28d formed continuous with the second R shape R2. In another embodiments, for example, the shaft 26 may include at least one of the second tapered part 27d and the fourth tapered part 28d. For example, the first shaft part 27 may not include the second tapered part 27d. In this case, the first R shape R1 may be provided at the protruding end of the first shaft part 27.

What is claimed is:

1. A rotation device comprising:
one or more plates that define a part of a flow path; and
a plurality of vanes that are disposed in the flow path, each of the plurality of vanes including;
a vane body that is located in the flow path; and
a shaft that is rotatably supported by one or more holes provided in the one or more plates, the shaft including an R shape at both ends in the axial direction of a contact part between the shaft and the one or more holes.

2. The rotation device according to claim 1, wherein the shaft includes at least one tapered part that is formed continuous with the R shape, and
the at least one tapered part is at least partially arranged inside of the one or more holes.

3. The rotation device according to claim 1, wherein a radius of the R shape is 0.5 mm or more and 1.0 mm or less.
